(19) United States
(12) Patent Application Publication
(10) Pub. No.: US 2004/0244406 A1
(43) Pub. Date: Dec. 9, 2004

(54) Electrodynamic energy converter and refrigerating plant based thereon

(76) Inventors: Anatoly-Ivanovich Savitsky, Malysheva Street (RU); Gennady-Ivanovich Bumagin, Omsk (RU); Andrei-Anatolyevich Sukhikha, Polyarnaya St (RU)

Correspondence Address: MCKENNA LONG & ALDRIDGE LLP, 1900 K STREET, NW, WASHINGTON, DC, 20006, US

(21) Appl. No.: 10/487,680

(22) PCT Filed: Aug. 25, 2001
(86) PCT No.: PCT/KR01/01440

(51) Int. Cl. H02K 1/00; H01T 23/00; H01T 19/04; F25B 1/00

(52) U.S. Cl. 62/498; 310/10; 361/230; 250/324

(57) ABSTRACT

The invention relates to electrodynamic energy converters for use in electrical, chemical and gas industry, in cryogenic and refrigerating engineering for cooling a working medium and for moving dielectric liquids and gases. The electrodynamic converter comprises a corona discharge working chamber part for making corona discharge therein, for converting an electric energy into a fluid energy of a working medium, wherein the corona discharge working chamber part includes a plurality of corona discharge working chambers disposed parallel with a flow direction of the working medium, and the plurality of corona discharge working chambers are isolated from one another.

### TECHNICAL FIELD

The present invention relates to an energy converter, and more particularly, to an electrodynamic energy converter which can convert an electric energy into a fluid energy. The electrodynamic energy converters of this invention can be used in power, chemical and gas industry; in cryogenic, refrigerating engineering for cooling a working medium and pumping dielectric liquids and gases.

### BACKGROUND ART

The well known electro(hydro)(gas)dynamic energy converters (from hereon referred to as EDC), as a rule, have a channel with dielectric walls, through which a working medium flows and passes by emitter and collector electrodes connected to a high-voltage source. The working medium consists of dielectric liquids, including cryogenic fluids, gases, wet vapor, mixtures of gases with dispersible particles.

The principle of the EDC operation is as follows. When a voltage of a certain value is applied, a corona discharge appears between the electrodes, the working medium is ionized, and the interelectrode space is filled with a unipolar space charge with a polarity corresponding to the potential sign on the emitter. Under the action of the produced electric field and the space charge field, the formed unipolar charge is directed to the collector. As a result of viscous interaction of the charged working medium with other neutral mass of the working medium, the working medium moves to the collector. In so doing, the potential energy of the charges is converted into a kinetic energy of the flow, which at the collector output is transformed into potential pressure energy.

The single-channel EDC having one stage of conversion of electric energy into working medium energy, i.e. having one pair of electrodes and one working chamber, features low output and efficiency, due to a significant power loss when the working medium flows in the directions of the electric field lines which are not coincident with the channel axis.

Known in the art are electrohydrodynamic fluid pump in which the increase of capacity is achieved by increasing of the number of conversion stages. For example, the working medium flows into an axial channel made in the form of a series of corona discharge working chambers. (U.S. Pat. No. 3,267,860).

However, an increase of the number of conversion stages results in a rise of the hydraulic resistance of the channel, whose flow area is partially occupied by electrodes. If the hydraulic resistance increases, the flow pressure decreases, the working medium velocity rise up and the electric energy has no enough time to convert into potential energy but only to convert into a heat, which elevates a temperature of the working fluid, that drops an efficiency of the energy converter.

Also known in the art is a pump for dielectric liquids in which the dielectric housing has a plurality of parallel channels. (U.S. Pat. No. 3,267,859). In this case, the like charges, which are not isolated from each other, render negative effect on each other, reducing the charge-forming capability of the electrodes and reducing the break-down voltage of the corona discharge.

Known in the art is an electrodynamic charger having a plurality of parallel channels, each of which has several consecutive stages of conversion formed by alternating emitter and collector electrodes (Mysgrov P. J. The prospects for electrogasdynamic energy conversion. Electric Review, 1971, p.403-405).

However, the installation of identical stages in a parallel-serial row results in superposition and mutual negative effect of the electric fields of the adjacent channels having like bulk charges in the interelectrode space, and results in a “locking” effect of the bulk charge electric field on the output of charged particles into the flow of charged particles.

Making the channels of several consecutive stages, which are not insulated from each other, results in worsening the operating conditions of the stage in comparison with the single-stage construction. This is explained by mutual negative effect of the electric fields of the stages on each other and also by the incomplete recombination of the charges on the collector electrode. The infiltration of some of charges into the working zone of the following stage interferes with the output of the like charges from the electrode of the following stage, and thus the breakdown voltage of the corona discharge is reduced. In so doing, the penetrating charges are decelerated in the electrode field of the following stage, and the neutral particles, which are carried away by these charges, are also decelerated. As a result, the velocity of the working medium flow is decreased, and thus the efficiency of the electrodynamic converter or the electrodynamic charger is decreased.

Besides, provision of the multistage electrodynamic converter or electrodynamic charger with stages having similar geometrical parameters results in a decrease of flow velocity from stage to stage, an increase of the bulk charge in the corona discharge working chambers, and an increase of the negative effect of the bulk charge field on the operation of the stage because increasing of the working medium density reduce to increasing quantity of the particles polarized with the unlike charge near emitter and the electric power for corona discharge needed for start must be more. The power loss of the high voltage source for overcoming the bulk charge field is increased when the regular charges come into the working chamber, as well as losses associated with to the flow of charges onto the walls of the channels, as well as associated that also reduces the EDC efficiency.

Another EDC known in the art is based on a multichannel circuit, which comprises self-contained channels made in a dielectric housing in parallel to each other and having electrodes connected alternately to the unlike terminals of a high-voltage source.(RU, A, 2112155) In this case, in order to increase the recombination of the ion flow, deionizers are provided in the housing in parallel to the working medium flow.

Such a circuit diagram requiring a plurality of lead wires and a multilayer isolation of unlike electrodes is technologically disadvantageous.

Due to the fact that the value of the breakdown voltage is different for charges of a different polarity, and the process of ionization with a negative-polarity charge former results in deposition of the positive electrode material on the negatively charged pointed end of the electrode, the EDC operation is worsened in due time. On the contrary, the process of ionization with a positively charged charge former results in an effect of “self-sharpening” of its points. Besides, the hydraulic resistance of the structural elements of the channel increases during the movement of the flow of charged particles.

The above described arrangement of the deionizers set in parallel to the working medium flow does not prevent the infiltration of the charged part of the working medium into the working chamber of the subsequent stage to the electrode-emitter having an opposite electric potential and this results in a reduction of the break-down voltage of the corona discharge.

The inventors of the claimed invention have a purpose of creating an electrodynamic converter for converting the energy of liquids and gases having advanced output-pressure head characteristics, low hydraulic losses along the pass of the working channel and maximum recombination of the ionized part of the working medium flow, as well as a reduced mutual negative effect of the electric fields of the adjacent stages and electrodes.

The known refrigerating plant comprises, at least, a compressor, a condenser, a throttle, an evaporator installed in a closed loop, in which a working medium flows, and a compressor connected to an electric power supply. The operation of this system is based on the principle of transferring the heat from a low-potential source of heat (cold consumer) to a high-potential source of heat in a back cooling cycle by means of the compressor consuming electric energy. In so doing, the electric energy is converted in the compressor into a potential energy of a working medium, in the condenser the heat is transferred from the working medium to the environment, in the throttle chamber the working medium is expanded to reduce its pressure and temperature, and in the evaporator the heat from the low-potential source of heat is transferred to the working medium, then the working medium is fed to the compressor input.

In this case the efficiency (refrigerating factor) of the refrigerating plant depends mainly on the thermodynamic properties of the working medium, the temperature level of evaporation and condensation, the working medium flow rate and on the efficiency of the devices functioning as condenser, throttle, and evaporator.

When the refrigerating plants are equipped with mechanical compressors having moving parts requiring lubricants, the oil vapors are absorbed by the working medium and during the movement of the working medium in the closed loop are settled on the surfaces of the structural elements of the devices creating oil films hindering the operation of the whole system.

The cold producing capacity of the refrigerating plants with mechanical compressors can be controlled by switching the compressor on and off and this results in overloads at start-up and unstable operation of the compressor.

Now much attention is paid to replacement of the compressors in the refrigerating plants by electrodynamic energy converters or chargers having no moving structural elements and providing high flow rate-pressure head characteristics in a wide range of density of the working mediums to be used.

The electrodynamic energy converters must provide high efficiency of the process of energy conversion with high manufacturability, convenience in operation, maintainability and safety, as well as a possibility of smooth regulation of their output capacity.

### DISCLOSURE OF THE INVENTION

The basic object of the present invention is to develop an electrodynamic energy converter whose design would provide the optimal conditions of conversion of the working medium energy by providing conditions for a stable directed corona discharge by placing a charge-forming pointed end of the electrode-emitter in the corona discharge working chamber, said electrode being spaced from the collector for a distance optimal for forming the corona discharge, to reduce the cost of the consumed electric power due to a reduced corona discharge break-down voltage on the emitter, and to provide conditions for complete recombination of the charged ions of the working medium during its movement through a grounded current-carrying structural element permeable for the working medium.

Another object of the invention is to provide a controllable electrodynamic energy converter with predetermined parameters of the flow rate and pressure of the working medium at the outlet by means of a multichannel and/or the multistage system of energy conversion with a simultaneous decrease of the working medium temperature at the outlet.

Another object of the invention is to provide an electrodynamic energy converter, which can be fabricated, and assembled simply, and can be maintained with ease.

Still another object of the invention is to develop a refrigerating plant providing a high cold producing capacity with a significant saving of power consumption due to the use of an electrodynamic converter as a compressor and partially as a condenser of the refrigerating plant. This makes it possible to avoid penetration of oils into the working medium, and this, in turn, provides the absence of oil films in the cold chamber and increases the heat transfer efficiency.

To achieve these and other advantages and in accordance with the purpose of the present invention, as embodied and broadly described, the elelctrodynamic energy converter includes a corona discharge working chamber part for making corona discharge therein, for converting an electric energy into a fluid energy of a working medium, wherein the corona discharge working chamber part includes a plurality of corona discharge working chambers disposed parallel with a flow direction of the working medium, and the plurality of corona discharge working chambers are isolated from one another.

The electrodynamic energy converter further includes one housing in which the working chambers are fitted.

Preferably, the plurality of working chambers are formed by a front sleeve and a rear sleeve. The front sleeve has a plurality of flowing channels and is arranged in front of an emitter fitted in a position of the housing. The rear sleeve has a plurality of flowing channels and is arranged in rear of the emitter.

Preferably, the housing is formed of an electric conduction material, and is grounded.

Preferably, the pointed end of the emitter is fitted substantially perpendicular to the flow direction of the working medium or is fitted in the flow of working medium.

The electrodynamic energy converter further includes a deionizer formed of an electric conduction material and grounded, for neutralizing charged particles flowing from the working chamber.

Preferably, the deionizer is fitted perpendicular to the flow direction of the working medium. More preferably, the housing and is grounded.

The electrodynamic energy converter further includes a current-carrying member fitted in parallel with the flow direction of the working medium for applying a high voltage to the emitter. Preferably, the current-carrying member is fitted passing through the front sleeve and the rear sleeve.

The electrodynamic energy converter further includes a front cover having a plurality of flowing channels fitted at an inlet side of the housing, and a rear cover having a plurality of flowing channels fitted at an outlet side of the housing.

Preferably, the front sleeve includes an extension extended from one side of the front sleeve in a rear sleeve direction. The extension has an opening at an outer circumference thereof opened to an inside wall direction of the housing.

Preferably, the front sleeve has a recess in an outside surface, and the rear sleeve has an insert on an inside surface in conformity with the recess in the front sleeve. More preferably, the recess is conical.

Preferably, the rear sleeve has an assembly part on an outside surface for fitting the deionizer of a ring form.

Preferably, the emitter is planar and fitted between the front sleeve and the rear sleeve.

Preferably, the housing of the electrodynamic energy converter has cooling part on an outside surface for cooling down.

Preferably, the rear sleeve has an assembly part on an outside surface for fitting the deionizer.

According to this invention, the electrodynamic energy converter includes a housing, an emitter, and a collector, wherein there is a current-carrying member fitted in parallel with an axial direction of the housing for applying a high voltage to the emitter.

Preferably, the current-carrying member is fitted in the housing.

According to this invention, the electrodynamic energy converter comprises at least one module, including a housing made of a electric conduction material having an input channel, an output channel and an internal space for inlet and outlet of a working medium, the housing being grounded; a front cover made of a dielectric material and fitted in the internal space of the housing, the front cover having at least one flowing channel in a peripheral part thereof; a front sleeve made of a dielectric material and fitted in the internal space of the housing, the front sleeve having at least one flowing channel in a peripheral part thereof; a rear sleeve having made of a dielectric material and fitted in the internal space of the housing, the rear sleeve having at least one flowing channel in a peripheral part thereof, the flowing channel of the rear sleeve is open toward the internal surface of the housing, a corona discharge working chamber being formed between the front sleeve, the rear sleeve and the housing; a rear cover made of a dielectric material and fitted in the internal space of the housing, the rear cover having at least one flowing channel in a peripheral part thereof, the flowing channels of the front cover, the front sleeve, the rear sleeve and the rear cover communicating with each other; an emitter having on its periphery at least one projection with a pointed end, the pointed end being located in the corona working chamber; a gas-and-liquid permeable deionizer mounted in the flowing channel of the rear sleeve; and, a current-carrying member for applying a high-voltage D.C. to the emitter, the current-carrying member being disposed in the center along the longitudinal axis of the housing, whereby the housing, the front sleeve, the emitter, the rear sleeve and deionizer forms a pressure stage.

Furthermore, these and other objects were attained by creating an electrodynamic energy converter comprising at least one module including a metal housing having an input and an output channels for inlet and outlet of the working medium, respectively, and an internal cylindrical space communicating with the input and output channels, in which a metal current-carrying rod is disposed in the center along the longitudinal axis of symmetry, said rod being adapted for connection with a high-voltage D.C. source and carries mounted in succession removable members made of a dielectric material, being adjacent to the internal surface of the housing and adjacent to each other, said members including a front cover, at least one front sleeve and one rear sleeve and a rear cover; the peripheral part of each of said covers and sleeves has at least one flowing channel; said flowing channels communicating with each other; the flowing channels of the front and rear sleeves are open towards the internal surface of the housing and form a corona discharge working chamber between themselves and the housing; mounted on the current-carrying rod between said front and the rear sleeves are a removable emitter made with a possibility of being fixed against a turn about the front sleeve and having on its periphery at least one projection with a pointed end, said pointed end being located in said corona discharge working chamber; mounted in the flowing channel of the rear sleeve at the outlet of the working chamber is a gas-and-liquid permeable deionizer adjoining the internal surface of the housing; said front sleeve, emitter, rear sleeve and deionizer form a pressure stage; and the housing module is grounded.

Thus, the working chambers are not subjected to the harmful effect of the electric fields of the charges of the adjacent working chambers, providing the working medium velocity in the flowing the channels specified by the structural elements and producing a corona discharge at a distance equidistant from the internal surface of the housing and the butt end of the deionizer, and providing the complete recombination of the flow of charged ions at the outlet of each corona discharge working chamber. In so doing the electric power necessary for generation of a breakdown voltage between the emitter and collector, which according to the invention is formed by the walls of the housing and deionizer, is much less than in the above described electrodynamic chargers and converters.

Furthermore, according to the invention, the housing of the module is made with a possibility of its cooling that allows one to lower the working medium temperature at each conversion stage and at the converter outlet.

In so doing, according to the invention, the external surface of the housing of the module is spatially developed. It can be made, for example, using ribs, projections or other structural elements extending above the external surface of the housing, for example, using the deforming cutting technology.

According to the invention, the deionizer is made in the form of an annular insert.

Furthermore, according to the invention, the deionizer is made in the form of a set of ring membranes.

In so doing, according to the invention, the deionizer is made of a material selected from the group including metal-ceramic materials and metal nets.

In so doing, according to the invention, it is desirable, that the deionizer is made of a metal-ceramic material with a porosity of about 40% to about 60%.

According to the invention, it is desirable that the deionizer is made of a metal net with a total open flow area of about 40% to about 60% of the total area of the net.

The porosity or open flow area of the deionizer material provides a required open flow area of the working channels and is selected depending on the given working medium flow rate.

In so doing, according to the invention, it is desirable that the front cover, the front sleeve, the rear sleeve and the rear cover are made of fluoroplastic. Such a finish of the sleeves provides a high degree of insulation of the current-carrying rod, its inertness to the working medium and a low friction coefficient.

The object of the invention is also attained by providing an electrodynamic energy converter, in which each of said front cover, said front sleeve, said rear sleeve and said rear cover has a number N of flowing channels, the flowing channels of the front and rear sleeves form N of the corona discharge working chambers and the emitter has N pointed ends, and each pointed end of N pointed ends being located in the corona discharge working chamber of N corona discharge working chambers.

Thus, it is possible to structurally provide a necessary open flow area of the flowing channels for maintenance of the given capacity of the electrodynamic converter and a given flow rate of the working medium.

The object of the invention is also attained due to the fact that in the electrodynamic converter, according to the invention the front sleeve, emitter, rear sleeve and deionizer forming one pressure stage are installed in the internal space of the housing on the current-carrying rod with said consecutive alternation of M times to form M pressure stages that allow one to provide a necessary output pressure of the working medium.

The object of the invention is also attained due to the fact that the electrodynamic energy converter comprises P number of modules connected in series; in so doing the output channel of each previous module being connected to the input channel of each next module and this allows one to develop the electrodynamic converter with predetermined power characteristics.

The object of the invention is also attained by creating a refrigerating plant comprising units connected in series through the pipelines of the a working medium pipes, said units including a compressor, a condenser, a throttling device, an evaporator located in a cooling chamber of a cold consumer, a device for connection of the compressor to an A.C. power supply network and regulation of the cold producing capacity of the refrigerating plant having at least one output connected to the compressor, and a temperature control device to control the temperature in the cooling chamber including a temperature detector placed inside the cooling chamber, a temperature controller, and a matching unit, characterized in that the compressor is an electrodynamic energy converter according to the invention the device for connection of the compressor further comprises a high-voltage D.C. source which is made with a possibility of continuous control of the voltage at its outputs electrically connected to the matching unit and has a number of outputs at least corresponding to the number of modules in said electrodynamic energy converter; the value of the voltage at each output is differentiated, the current-carrying member of each module being connected to one of the outputs of the high-voltage D.C. source.

In addition, according to the invention, the cold producing capacity of the refrigerating plant is effected by varying the value of the voltage at the outputs of the high-voltage D.C. source.

In so doing, according to the invention, the value of the voltage at the output of the high-voltage D.C. source is set up discretely and controlled by steps of about 10 kV up to about 20 kV.

### BRIEF DESCRIPTION OF THE DRAWINGS

The invention is further described by way of example not limiting the present invention with reference to the appended drawings, in which:

FIG. 1 illustrates a section across I-I line showing an electrodynamic energy converter in accordance with a preferred embodiment of the present invention;

FIG. 2 illustrates a section across II-II line in FIG. 1;

FIG. 3 illustrates a section across III-III line in FIG. 1;

FIG. 4 illustrates an enlarged section of ‘A’ part in FIG. 1;

FIG. 5 illustrates a section showing one pressure stage in FIG. 1;

FIG. 6 illustrates a perspective, disassembled view of FIG. 5;

FIG. 7 illustrates a section showing an electrodynamic energy converter in accordance with another preferred embodiment of the present invention;

FIG. 8 illustrates a perspective, disassembled view of FIG. 7;

FIG. 9 illustrates a section showing an electrodynamic energy converter in accordance with still another preferred embodiment of the present invention;

FIG. 10 illustrates a perspective view of a variation of an emitter of the present invention;

FIG. 11 illustrates a section showing a current-carrying member of the present invention applied to other energy converter, schematically;

FIG. 12 illustrates a diagram showing a system of refrigerating plant having the electrodynamic energy converter of the present invention applied thereto.

### BEST METHOD OF CARRYING OUT THE INVENTION

The electrodynamic energy converter according to the present invention may be illustrated by its embodiments shown in the appended drawings. According to the present invention, the electrodynamic energy converter can comprise plurality “pressure stage” and/or plurality “working chambers” enough for adjusted flow pressure drop P, pressure H or for adjusted bulk (or mass) charge Q of the working medium.

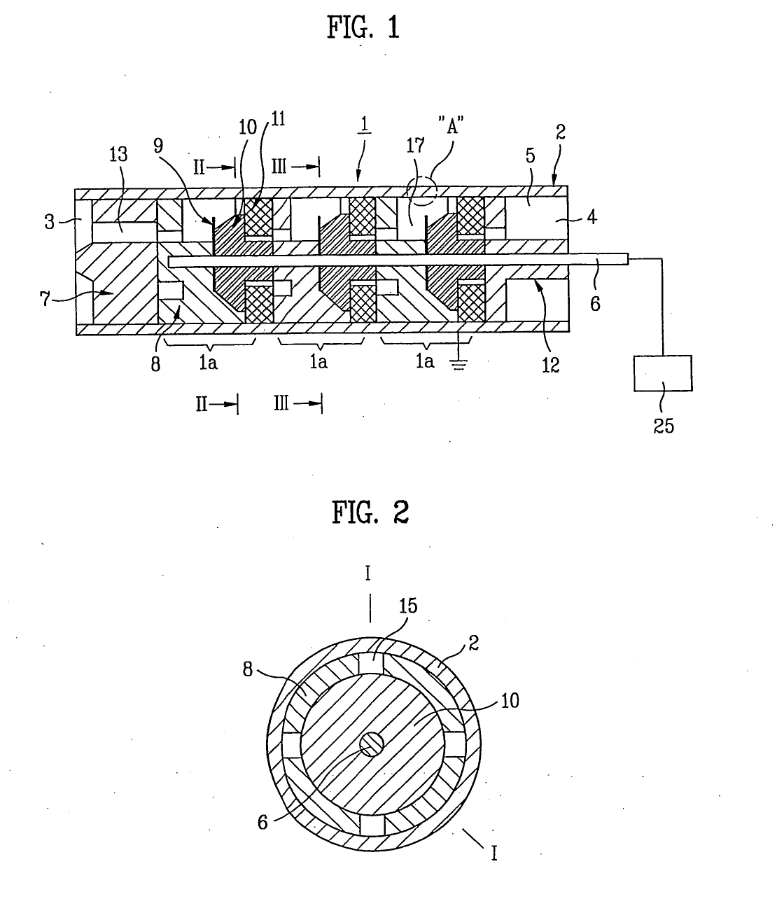

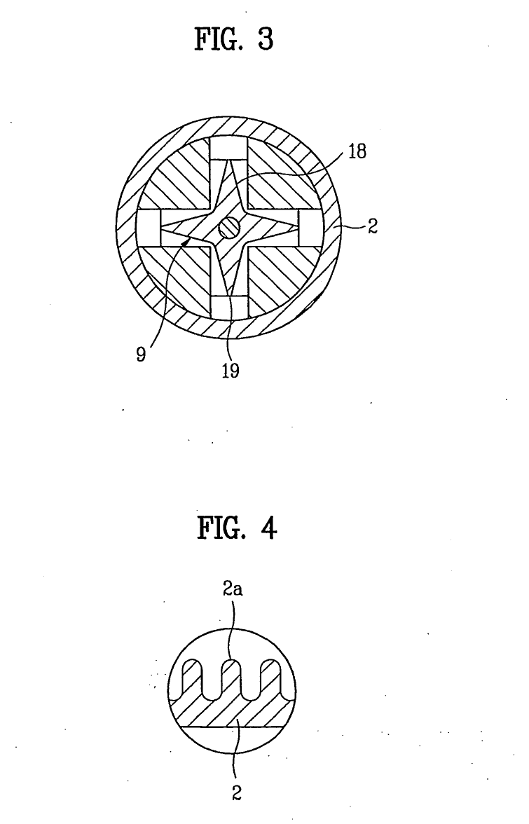

The electrodynamic energy converter in accordance with a preferred embodiment of the present invention will be explained with reference to FIG. 1, FIG. 2 and FIG. 3 shown one of the embodiment, The electrodynamic energy converter includes three energy conversion stages (hereafter, “pressure stage”), each 1a of which has four(4) corona discharge working chambers 17 (hereafter, “working chamber”). That is, there are a plurality of the working chambers 17 arranged in parallel in one of the pressure stages 1a, which stages 1a are arranged in a series to form one module 1. Therefore, according to the present invention, numbers of the working chambers 17, the pressure stages 1a, and the modules 1 can be fixed as necessary. That is, more than one pressure stages 1a may be combined appropriately, and the number of the working chambers 17 can also be adjusted appropriately even in one pressure stage 1a, as necessary. However, if there are two, or more than two working chambers 17, each of the working chambers 17 is isolated from the other.

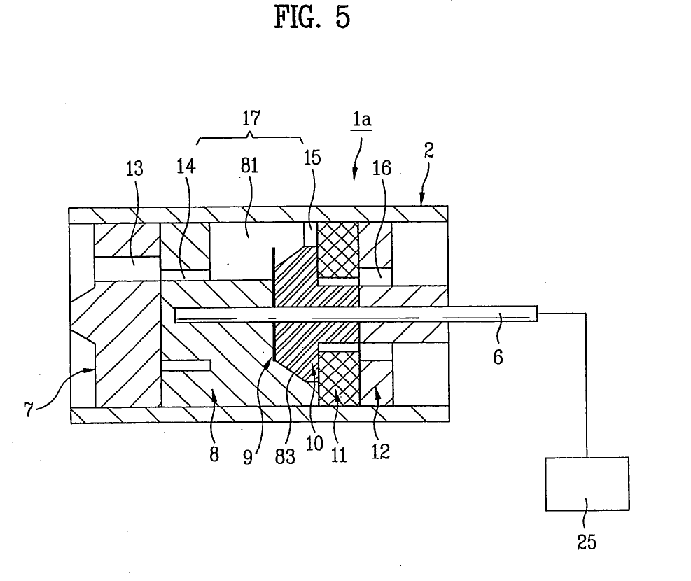

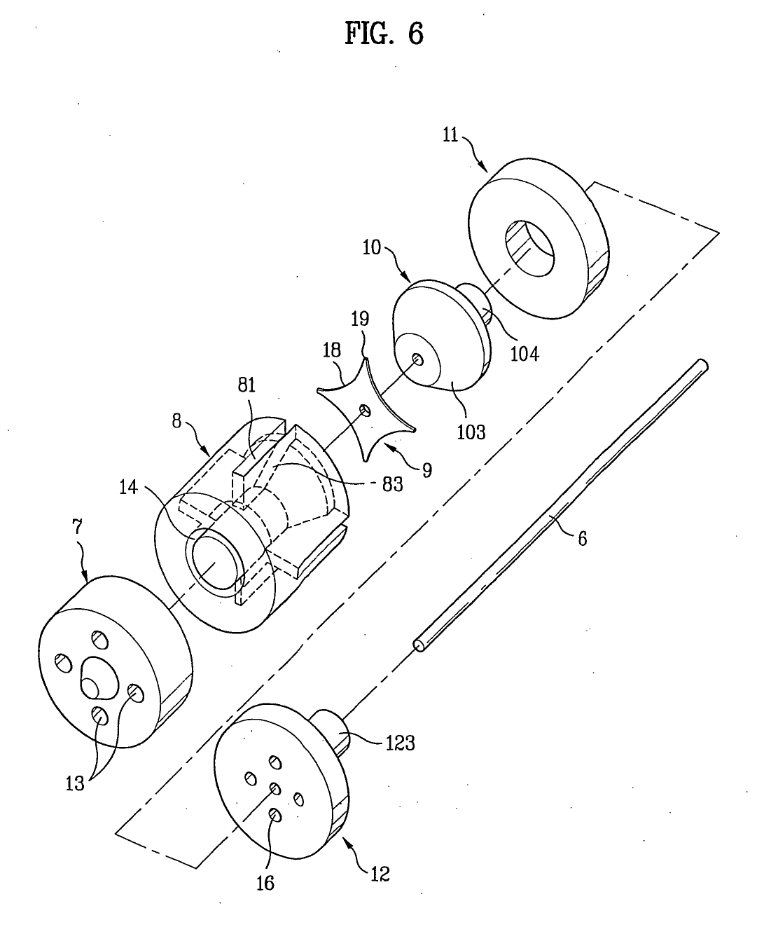

One of the pressure stages will be explained, with reference to FIGS. 4 and 5.

The pressure stages 1a are fitted inside of a housing 2. The housing 2 of a cylindrical or tube form has an internal space with one side serving as input channel 3 for introduction of a working medium thereto, and the other side serving as an output channel 4 for discharge of the working medium therefrom. The pressure stage 1a has at least one, preferably, two, or more than two working chambers 17, which are parallel to a flow direction, and are isolated from each other. In detail, there is an emitter 9 disposed at a position inside of the housing 2, and a front sleeve 8 and a rear sleeve 10 in front and rear of the emitter 9, respectively. That is, a space formed by the housing 2, the front sleeve 8, and the rear sleeve 10, is the corona discharge working chamber 17, with the emitter 9 fitted in a position of the working chamber 17, for making discharge therein. Though a collector may be fitted at a position in the working chamber 17 in correspondence to the emitter 9, it is preferable that the housing 2 is used as the collector, despite the collector can be fitted, additionally. That is, it is preferable that the housing 2 is formed of a conductive material, such as a metal alloy, and grounded. It is preferable that a deionizer 11 is fitted to a rear end of the rear sleeve 10 additionally, for neutralizing particles ionized at the working chamber 17 before the particles are introduced into the next stage, when both the housing 2 and the deionizer 11 can be used as the collector. When the deionizer 11 is fitted, only the deionizer 11 may be grounded, so that the deionizer 11 serves both as the collector and the deionizer. It is preferable that there is a front cover 7 in front of the front sleeve 8 having a flow channel 8 formed therein, and a rear cover 12 in rear of the rear sleeve 10 having a flow channel formed therein.

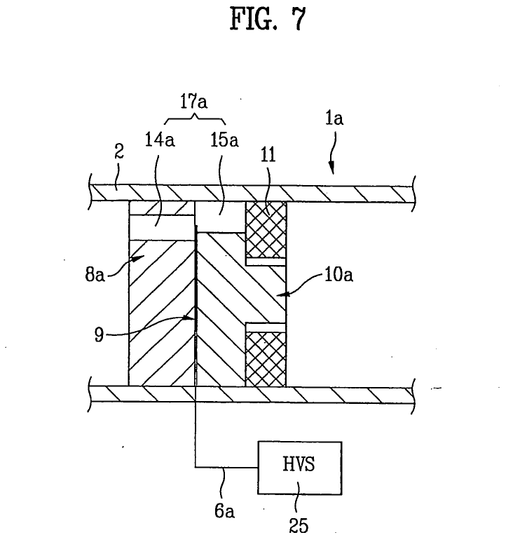

In the meantime, it is required that the emitter 9 has a high voltage applied thereto for causing a discharge at the working chamber 17. As shown in FIG. 7, an electric conduction line 6a may be connected between a high voltage source 25 and the emitter 9. However, as shown in FIG. 5, it is preferable that a current-carrying member 6 of an appropriate form disposed parallel to a flow direction may be used in view of assembly, and the like. Further, as shown in FIG. 11, this feature, that the current-carrying member 6 is used for applying a high voltage and disposed in parallel with a casing 31 (or the flow direction), can be used in the conventional electrodynamic energy converter. The reference numerals 33 and 35 indicate a emitter and a collector, respectively, in FIG. 11.

Meanwhile, as shown in FIG. 4, it is preferable that an outside wall of the housing 2 has a cooling part 2a such as cooling fins for cooling down the energy converter.

Respective elements will be explained in detail.

As explained, the front cover 7, the front sleeve 8, the emitter 9, the rear sleeve 10, the deionizer 11, and the rear cover 12 are arranged in succession along a direction of movement of the working medium.

It is preferable that a current-carrying member 6 is installed in the center of the internal space 5 of the housing 2 along its longitudinal axis. The member 6 can have a round, square or another cross section technologically providing installation of module structural elements on the member. The member 6 is adapted for connection to a high-voltage D.C. source, and has a positive polarity.

The sleeves 8, 10 and covers 7, 12 are made of a dielectric non-wettable material featuring physical and chemical stability with respect to the working medium, for example, made of a fluoroplastic material.

The front cover 7, the front sleeve 8, and the rear cover 12 have an external diameter close to the diameter of the internal space 5 of the housing 2.

The covers 7, 12 and the sleeves 8, 10 has four flowing channels, respectively, 13, 14, 15 and 16 made, for example, as openings or slots communicating with each other to form four longitudinal working channels inside the module 1. The flowing channel 15 of the rear sleeve 10 is open towards the internal surface of the housing 2.

The number of the communicating with each other flowing channels in each sleeve and cover may be selected different depending on the necessary number of working channels in the module 1. According to the invention, the flowing channels preferably disposed uniformly along the circumference of the peripheral part of the sleeves.

The flowing channels 14 and 15 form a corona discharge working chambers 17.

In the meantime, in order to provide a more appropriate corona discharge working chamber, it is preferable that one side of the front sleeve 8 is extended in a direction of the rear sleeve 10, to form an extension, and an opening 81 is formed in the extension in a direction of an inside wall of the housing 2. It is preferable that a recess 83 is formed in an outside surface of the extension of the front sleeve 8 in an axial direction, and an insert 103 is formed on an inside surface of the rear sleeve 10 in conformity with the recess 83 in the front sleeve 8. It is more preferable that the recess 83 in the front sleeve 8 and the insert 103 on the rear sleeve 10 are conical.

It is preferable that the emitter 9 is fitted substantially perpendicular to a flow direction in view of assembly and the like. In this instance, the emitter 9 is preferably formed of thin plate. In detail, the emitter 9 is made of a metal alloy in the form of a disk and has on its periphery four radial projections 18 with pointed ends 19. The emitter is installed on the current-carrying member 6 so that the pointed ends 19 are placed in the corona discharge working chambers 17. To avoid asymmetrical position of the pointed ends 19 of the emitters 9 in the corona discharge working chamber 17, the emitter 9 is secured against any turn relative to the front sleeve 8, for example, with the help of a pin or a bushing key. If the current-carrying member 6 has a non-circular cross, it is fixed against turning simultaneously with fixing of the sleeves.

The deionizer 11 is made as a gas-and-liquid impermeable perforated member of a stainless foil having a thickness of 0.05 cm. According to the invention, the deionizer 11 may be made as a single member or as a plurality of permeable membranes of a current-conducting material selected from the group of metal-ceramic materials or steel nets. In so doing, according to the invention, the porosity of the metal-ceramic material and the total open flow areas of the net should be from about 40% to about 60%, and this is conditioned by the required open flow area of the working channel for a given working medium flow rate.

Even if any deionizer 11 can be used as far as the deionizer 11 meets the foregoing requirements, it is preferable that a shape of the deionizer 11 is fixed taking convenience of assembly into account, preferably in a ring form. That is, an assembly part 104 is formed on an outside surface of the rear sleeve 10 in conformity with a hollow in the deionizer 11, for coupling the assembly part 104 and the hollow.

The structural elements installed on the current-carrying member 6 can be fixed against movement in the longitudinal direction, for example, by flanges on the front and rear covers of the module (not shown) while providing a tight joint between the housing and the covers.

Though the foregoing embodiment shows the emitter 9 provided as a separate component, the present invention is not limited to this. That is, the emitter 9 may be formed as one unit with the front sleeve 8 or the rear sleeve 10 at one side thereof, or the emitter 9, the front sleeve 8, and the rear sleeve 10 may be formed as one unit, or furthermore, the emitter 9, the front sleeve 8, the rear sleeve 10, and the housing 2 may be formed as one unit.

According to the invention, the modules of the electrodynamic energy converter having a different number of working channels and different number of pressure stages can be made in a similar manner.

From the description of the embodiment of the module it is apparent that it is possible to make different versions of the housing, sleeves, covers, current-carrying member, emitter, deionizer providing serviceability of the module and the required flow rate and pressure head characteristics.

The electrodynamic energy converter according to the invention may comprise a different number of modules connected in series; in so doing, depending on the characteristics of the working medium at the input of each module, one can provide optimum parameters of the working channels, corona discharge working chambers, open flow areas different for each module and predetermined flow rate and pressure head characteristics of the module and of the electrodynamic converter itself.

According to the invention, the working medium in the electrodynamic energy converter can be dielectric liquids and gases, mixtures of a gas with dispersible solid and liquid particles or vapor, as well as media in a biphase state such as vapor-liquid-wet vapor having physical and chemical stability during the corona discharge and electrochemical stability of molecules during the whole life time of the converter, with a value of the corona discharge breakdown voltage not lower than 50 kV/cm, for example, methane, hydrogen, oxygen, carbon fluorides Cₙ Fₘ, for example, CF₄, C₂F₆, C₃F₈, sulfur hexafluoride SF₆, organosilicone liquid copolymers.

The electrodynamic converter is operative as follows.

The working medium flows through the input channel 3 into the internal space 5 of the housing 2 of modules 1, and then flows into the corona discharge working chamber 17 through the flowing channel 13 of the front cover 7 and the flowing channel 14 of the front sleeve 8.

The current-carrying member 6 connected to the high-voltage D.C. source is fed with a voltage whose value is higher than the initial voltage of the corona discharge, for example, higher then 50 kV/cm. A unipolar bulk charge with a positive polarity is formed in the working chambers 17 between the pointed ends 19 and the walls of the housing 2 and deionizer 11.

Under the effect of forces of the electric field, the bulk charge begins to move along the field lines to the walls of the housing 2 and [to the butt end of] the deionizer 11. As a result of the viscous interaction between the charges and the neutral molecules, all working medium starts moving in a direction of movement of the charge. The larger the bulk charge, the higher the viscous interaction of the charge with the neutral molecules of the working medium and the higher the velocity and pressure of the working medium at the working chamber outlet will be run up. After the charged particles (ions) have reached the surfaces of the housing 2 and passed through the deionizer, the charge recombines and the neutral working medium further flows through the flowing channels to the next pressure stage or to the outlet of the module.

Thus the energy of the high-voltage D.C. source applied to current-carrying member 6 is converted into kinetic energy and potential energy of the flow characterized, respectively, by the developed pressure drop P, pressure H and bulk (or mass) charge Q of the working medium completely or partially, depending on the efficiency of the above described processes. The pressure and temperature of the working medium at the outlet of the electrodynamic converter are higher than the pressure and temperature at its inlet.

Similarly to the above described embodiment there was made and tested an electrodynamic energy converter, according to the invention, comprising one module having 20 pressure stages and six working channels. Sulfur hexafluoride was used as a working medium.

The tests have shown that the pressure developed by one stage (with a closed output, i.e. at a zero flow rate), has made 0.02 bars. Since, with 20 stages of the converter, the definition of the adiabatic efficiency of the converter is rather difficult, for estimation of the power efficiency at some fixed pressure of about 0.1 bar obtained with the help of a throttle valve, relative value of M/W (flow rate per consumed power consumption) was used.

The test results are shown in Table 1.

TABLE 1

| | | | | Flow rate |
|---|---|---|---|---|
| Input pressure at | Voltage, | Current, | Flow rate, | to pow consump- |
| the input, P₁, bar | U, V | I, mA | M, g/s | tion, M/W, g |
| 7.04 | 13 | 1.3 | 2.5 | 0.14 |
| 9.02 | 14 | 0.67 | 2.8 | 0.30 |
| 10.99 | 15 | 0.31 | 2.8 | 0.59 |
| 13.00 | 16 | 0.25 | 3.6 | 0.90 |
| 14.99 | 17 | 0.15 | 3.8 | 1.44 |
| 17.01 | 18 | 0.11 | 4.0 | 2.20 |

The test results have shown that the efficiency of the electrodynamic converter according to the invention grows with a decrease of power consumption, however in this case the flow rate and pressure drop down and the efficiency rises up considerably with an increase of the working medium density.

This is explained by a decrease of the mobility of individual ions, a rapid growth of the ionized associations having directed movement, and an approach of the electrodynamic mechanism in the gas medium to processes occurring in the liquid media.

The data of the tests allow one to select a required amount of working medium for a predetermined flow rate, for example 2 g/s, to determine a necessary number of stages in the module and to determine a necessary voltage to be applied on the emitters. Since the working medium density varies considerably, the voltage value at the same mass flow rate through each pressure stage is preferably set up discretely, for example, from 12 kV to 16 kV with a step, for example, 0.5 kV for each module.

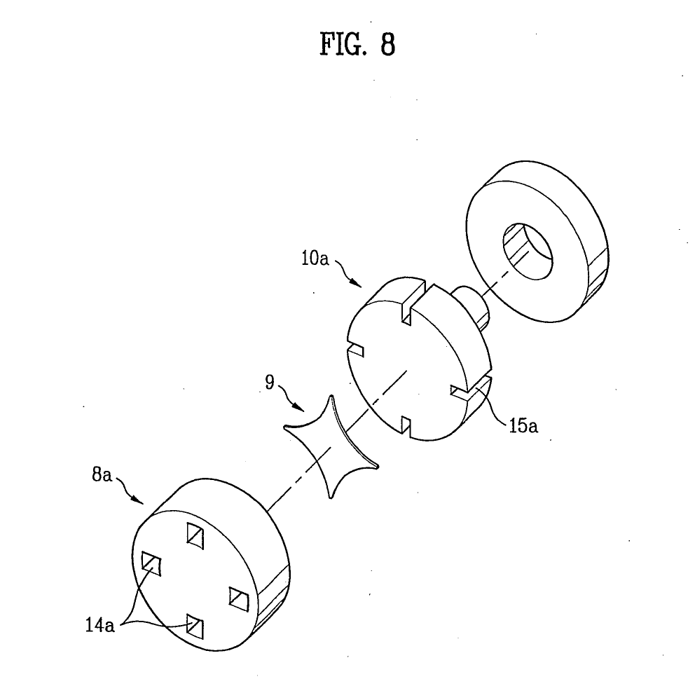

An electrodynamic energy converter in accordance with another preferred embodiment of the present invention will be explained, with reference to FIGS. 7 and 8.

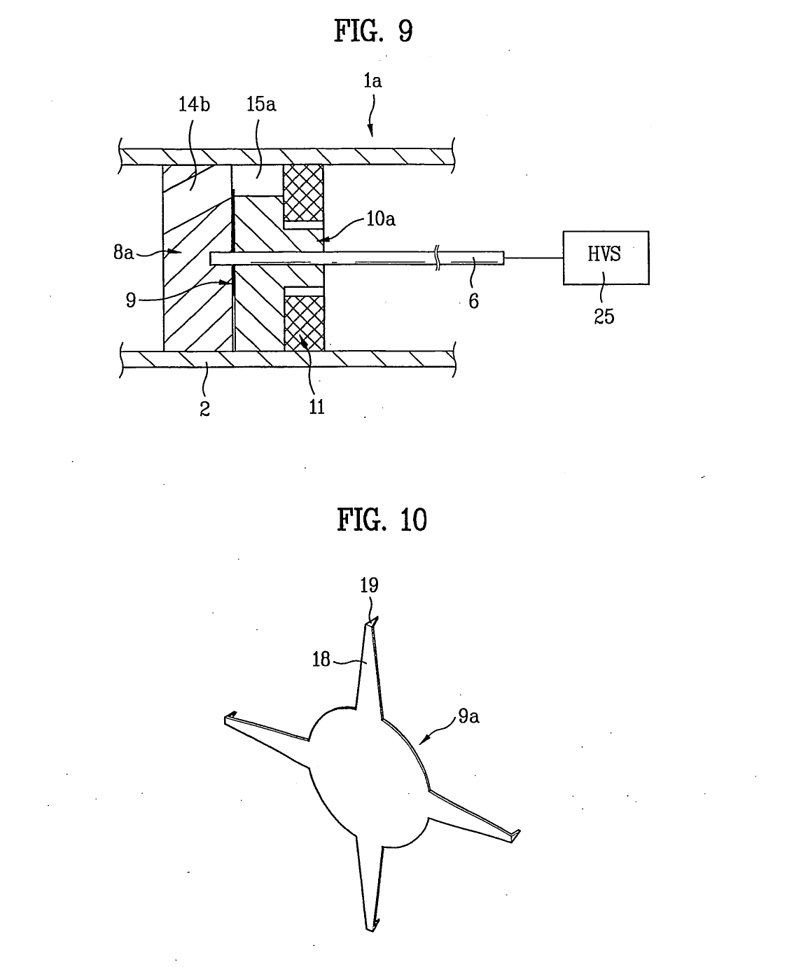

This embodiment is identical to the foregoing embodiment basically, except that there is no opening formed in the extension in the front sleeve 8a. That is, a flow channel 14a in a front sleeve 8a and a flow channel 15a in a rear sleeve 10a form a corona discharge working chamber 17a. However, an appropriate modification of the flow channel 14a and 15a in the front sleeve 8a and the rear sleeve 10a for providing a more appropriate working chamber 17a is also possible. For an example, the flow channel 14a in the front sleeve 8a may be designed to have a converge-diverge nozzle form, and the flow channel 15a in the rear sleeve 10a may be designed to have a diverge-converge form. Further, as shown in FIG. 9, it is possible that the flow channel 14b of the front sleeve 8a may be inclined. Also it is possible that, similar to the foregoing embodiment, a recess is formed in an inside surface of the front sleeve 8a at a center part thereof, and an insert is formed in an inside surface of the rear sleeve 10a, for easier assembly.

Referring to FIG. 7, though the high voltage source 25 is connected to the emitter 9 directly, a current-carrying member parallel with the flow direction may also be used like the foregoing embodiment.

Referring to FIG. 10, it is also possible that only the pointed end 19 of the emitter 9a is formed to be parallel with the flow direction while the emitter 9a is fitted perpendicular to the flow direction.

For the purpose of application of the electrodynamic converter as a compressor in a refrigerating plant, it is possible to calculate a number of modules in the compressor and a number of pressure stages in the module. For example, for a refrigerating plant with a cold producing capacity of 300 W, the electrodynamic converter may have 10 modules having a length of 1.2 m and an external diameters from 14 mm to 20 mm and 100 pressure stages with a voltage from 10 kV to be increased by step of 1 kV in each subsequent module. The cooling of the housing of the modules will allow one to increase the efficiency of compression and to shorten the cooling cycle.

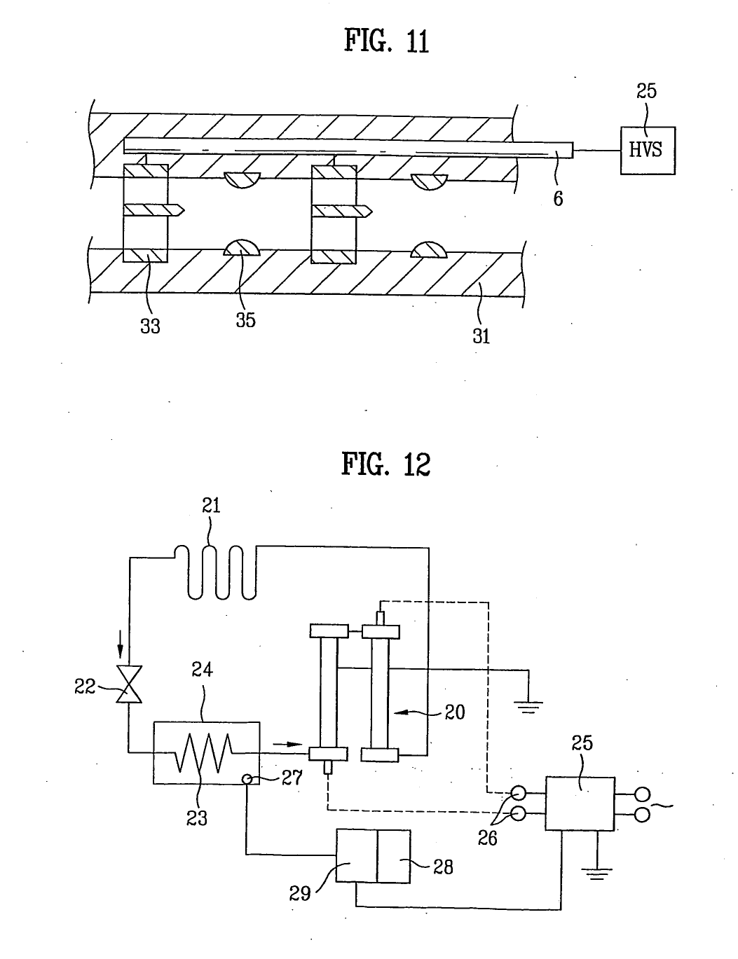

FIG. 12 shows a circuit diagram of a refrigerating plant according to the invention, in which the closed loop of the working medium line includes a compressor 20 in the form of an electrodynamic converter comprising, for example, two modules connected in series, a condenser 21, a throttle 22, an evaporator 23 placed into a cooling chamber 24 of the cold consumer. The compressor 20 is connected to a high-voltage D.C. source 25 connected to an A.C. electric network by connecting the current-carrying member 6 of each module 1 to one of the outputs 26 of the source 25, the housings 2 of each module 1 being grounded. The high-voltage D.C. source is made with a possibility of a continuous control of the voltage at its output in response to the input signal of the temperature control device.

The temperature control device comprises a temperature detector 27 installed inside the cooling chamber 24, a temperature controller 28 and a matching unit 29 connected to the high-voltage D.C. source.

The condenser 21, throttle chamber 22, evaporator 23, temperature detector 27, high-voltage D.C. source may be well known devices whose characteristics satisfy the needs of the refrigerating plant.

The refrigerating plant according to the invention operates by a backflow condenser cycle. The electrodynamic energy converter 20 according to the invention draws the working medium vapors (freon) from the evaporator 23 and then compresses the working medium at a required pressure rate. The process of compression is carried out successively in the modules 1 with simultaneous heat removal due to the developed surface of housings of modules 1 or due to forced cooling of these surfaces. Thus polytropic compression of the working medium is carried out that allows one to change the shape of the backflow condenser and to reduce the operating cycle time, in which case the electrodynamic converter partially operates as a normal condenser. Further the working medium condenses in the condenser 21 and expands in the throttle chamber 22 with reduction of pressure and temperature and enters the evaporator, where it takes heat from the consumer being cooled.

As soon as the temperature inside the cooling chamber 24 drops below a preset value controlled by the controller 28, the matching unit 29 send a control signal to the high-voltage D.C. source for smooth reduction of the voltage at its output, the voltage on the current-carrying members 6 of the modules 1 decreases and the pressure and working medium flow rate are reduced.

The compressor of the refrigerating plant according to the invention has no moving parts requiring a lubricant, therefore, the working medium has no oil inclusion and this improves the heat exchange characteristics of the condenser and evaporator.

The refrigerating plant according to the invention operates noiselessly, the control of the cold producing capacity is effected continuously without switching off the electric power source.

The design of the electrodynamic energy converter according to the invention allows one to install various devices on the housing of the modules or to place the modules in the devices so as to intensify the heat sink, that is promising for application in cryogenic engineering for liquefaction of working media.

The cylindrical form of the module housing allows one to provide full tightness including the case of using a high-pressure working medium.

The modular design of the converter according to the invention allows one to make each module with optimal design characteristics that makes it possible to considerably increase the effective efficiency of the entire converter.

Described above are examples of the devices according to the invention. Those skilled in the art understand that in the devices according to the invention high efficiency is obtained and that modifications and improvements can be made without departing from the scope of the invention stated in the appended claims.

### INDUSTRIAL APPLICABILITY

The electrodynamic energy converter according to the invention can be made of well-known materials using common technology providing a simple construction of the device, its maintainability, convenience in operation, as welt as compatibility with other devices with their joint application in different areas of industry.

1. An electrodynamic energy converter comprising a corona discharge working chamber part for making corona discharge therein, for converting an electric energy into a fluid energy of a working medium, wherein the corona discharge working chamber part includes a plurality of corona discharge working chambers disposed parallel with a flow direction of the working medium, and the plurality of corona discharge working chambers are isolated from one another.

2. An electrodynamic energy converter as claimed in claim 1, further comprising one housing the working chambers are fitted therein.

3. An electrodynamic energy converter as claimed in claim 2, wherein the plurality of working chambers are formed by a front sleeve and a rear sleeve, the front sleeve having a plurality of flowing channels, arranged in front of an emitter fitted in a position of the housing, and the rear sleeve having a plurality of flowing channels, arranged in rear of the emitter.

4. An electrodynamic energy converter as claimed in any of claims 1 to 3, wherein the housing is formed of an electric conduction material, and is grounded.

5. An electrodynamic energy converter as claimed in claim 4, wherein the pointed end of the emitter is fitted substantially perpendicular to the flow direction of the working medium.

6. An electrodynamic energy converter as claimed in claim 4, wherein the pointer end of emitter is fitted in the flow of working medium.

7. An electrodynamic energy converter as claimed in any of claims 1 to 3, further comprising a deionizer formed of an electric conduction material and grounded, for neutralizing charged particles flowing from the working chamber.

8. An electrodynamic energy converter as claimed in claim 7, the deionizer is fitted perpendicular to the flow direction of the working medium.

9. An electrodynamic energy converter as claimed in claim 7, wherein the housing is grounded.

10. An electrodynamic energy converter as claimed in any of claims 1 to 3, wherein there is a current-carrying member fitted in parallel with the flow direction of the working medium for applying a high voltage to the emitter.

11. An electrodynamic energy converter as claimed in claim 10, wherein the current-carrying member is fitted passing through the front sleeve, and the rear sleeve.

12. An electrodynamic energy converter as claimed in claim 1 or 2, wherein there is a front cover having a plurality of flowing channels fitted at an inlet side of the housing, and a rear cover having a plurality of flowing channels fitted at an outlet side of the housing.

13. An electrodynamic energy converter as claimed in claim 3, wherein the front sleeve includes an extension extended from one side of the front sleeve in a rear sleeve direction, having an opening at an outer circumference thereof opened to an inside wall direction of the housing.

14. An electrodynamic energy converter as claimed in claim 3, wherein the front sleeve has a recess in an outside surface, and the rear sleeve has an insert on an inside surface in conformity with the recess in the front sleeve.

15. An electrodynamic energy converter as claimed in claim 14, wherein the recess is conical.

16. An electrodynamic energy converter as claimed in claim 7, wherein the rear sleeve has an assembly part on an outside surface for fitting the deionizer of a ring form.

17. An electrodynamic energy converter as claimed in claim 7, wherein the emitter is planar, fitted between the front sleeve and the rear sleeve.

18. An electrodynamic energy converter as claimed in claim 17, wherein the emitter is formed as one unit with the front sleeve.

19. An electrodynamic energy converter as claimed in claim 17, wherein the emitter is formed as one unit with the rear sleeve.

20. An electrodynamic energy converter as claimed in claim 17, wherein the front sleeve, and the rear sleeve are formed as one unit.

21. An electrodynamic energy converter as claimed in claims 1 to 3, wherein the housing has cooling fins on an outside surface for cooling down.

22. An electrodynamic energy converter as claimed in claim 7 or 8, wherein the deionizer is made of a material selected from the group including metal-ceramic materials and a metal net.

23. An electrodynamic energy converter as claimed in claim 22, wherein the deionizer is made of a metal-ceramic material with a porosity of about 40% to about 60%.

24. An electrodynamic energy converter as claimed in claim 22, wherein the deionizer is made of a metal net with the total open flow area of about 40% to about 60% of the total net area.

25. An electrodynamic energy converter as claimed in claim 12, wherein the front cover, front sleeve, rear sleeve and rear cover are made of dielectric material.

26. An electrodynamic energy converter as claimed in claim 25, wherein the front cover, front sleeve, rear sleeve and rear cover are made of fluoroplastic.

27. An electrodynamic energy converter as claimed in claim 1, further comprising a deionizer formed of an electric conduction material and grounded, for neutralizing charged particles flowing from the working chamber.

28. An electrodynamic energy converter as claimed in claim 4, further comprising a deionizer formed of an electric conduction material and grounded, for neutralizing charged particles flowing from the working chamber.

29. An electrodynamic energy converter as claimed in claim 14, wherein the rear sleeve has an assembly part on an outside surface for fitting the deionizer.

30. An electrodynamic energy converter as claimed in claim 3, wherein the rear sleeve has an opening at an outer circumference thereof opened to an inside wall direction of the housing for forming the flowing channel.

31. An electrodynamic energy converter as claimed in claim 30, wherein the rear sleeve has an assembly part on an outside surface for fitting the deionizer.

32. An electrodynamic energy converter comprising a housing, an emitter, and a collector, wherein there is a current-carrying member fitted in parallel with an axial direction of the housing for applying a high voltage to the emitter.

33. An electrodynamic energy converter as claimed in claim 32, wherein the current-carrying member is fitted in the housing.

34. An electrodynamic energy converter comprising at least one module, including a housing made of a electric conduction material having an input channel, an output channel and an internal space for inlet and outlet of a working medium, the housing being grounded;
a front cover made of a dielectric material and fitted in the internal space of the housing, the front cover having at least one flowing channel in a peripheral part thereof;
a front sleeve made of a dielectric material and fitted in the internal space of the housing, the front sleeve having at least one flowing channel in a peripheral part thereof;
a rear sleeve having made of a dielectric material and fitted in the internal space of the housing, the rear sleeve having at least one flowing channel in a peripheral part thereof, the flowing channel of the rear sleeve is open toward the internal surface of the housing, a corona discharge working chamber being formed between the front sleeve, the rear sleeve and the housing;
a rear cover made of a dielectric material and fitted in the internal space of the housing, the rear cover having at least one flowing channel in a peripheral part thereof, the flowing channels of the front cover, the front sleeve, the rear sleeve and the rear cover communicating with each other;
an emitter having on its periphery at least one projection with a pointed end, the pointed end being located in the corona working chamber;
a gas-and-liquid permeable deionizer mounted in the flowing channel of the rear sleeve; and,
a current-carrying member for applying a high-voltage D.C. to the emitter, the current-carrying member being disposed in the center along the longitudinal axis of the housing,
whereby the housing, the front sleeve, the emitter, the rear sleeve and deionizer forms a pressure stage.

35. The electrodynamic energy converter comprising at least one module, including a metal housing, having an input channel and an output channel, respectively, for inlet and outlet of a working medium, and an internal cylindrical space, communicating with the input and output channels, in which a metal current-carrying rod is disposed in the center along the longitudinal axis of symmetry, said rod being adapted for connection with a high-voltage D.C. source and carries mounted in succession removable members made of a dielectric material, being adjacent to the internal surface of the housing and to each other, said members including a front cover, at least one front sleeve and one rear sleeve and a rear cover; the peripheral part of each of said covers and said sleeves has at least one flowing channel, respectively, said flowing channels communicating with each other; the flowing channels of the front sleeve and rear sleeve are open towards the internal surface of the housing and form a corona discharge working chamber between themselves and the housing; mounted on the current-carrying rod between said front sleeve and the rear sleeve are a removable emitter made with a possibility of being fixed against a turn about the front sleeve and having on its periphery at least one projection with a pointed end, said pointed end being located in said corona discharge working chamber; mounted in the flowing channel of the rear sleeve at the outlet of the working chamber is a gas-and-liquid permeable deionizer adjoining the internal surface of the housing; said front sleeve, emitter, rear sleeve and deionizer form a pressure stage, and the housing of the module is grounded.

36. An electrodynamic energy converter as claimed in claim 35, wherein the housing of the module is made with a possibility of its cooling.

37. An electrodynamic energy converter as claimed in claim 36, wherein the external surface of the housing of the module is spatially developed.

38. An electrodynamic energy converter as claimed in claim 35, wherein the deionizer is made in the form of an annular insert.

39. An electrodynamic energy converter as claimed in claim 35, wherein deionizer is made in the form of a set of ring membranes.

40. An electrodynamic energy converter as claimed in claim 35, wherein the deionizer is made of a material selected from the group including metal-ceramic materials and a metal net.

41. An electrodynamic energy converter as claimed in claim 40, wherein the deionizer is made of a metal-ceramic material with a porosity of about 40% to about 60%.

42. An electrodynamic energy converter as claimed in claim 40, wherein the deionizer is made of a metal net with the total open flow area of about 40% to about 60% of the total net area.

43. An electrodynamic energy converter as claimed in claim 35, wherein the front cover, front sleeve, rear sleeve and rear cover are made of fluoroplastic.

44. An electrodynamic energy converter as claimed in claim 35, wherein each of said front cover, front sleeve, rear sleeve and rear cover has a number N flowing channels, respectively; the flowing channels, respectively, of the front sleeve and the rear sleeve form N corona discharge working chambers; the emitter has N pointed ends, each pointed end of N pointed ends being located in the corona discharge working chamber of N corona discharge working chambers.

45. An electrodynamic energy converter as claimed in claim 35, wherein the front sleeve, emitter, rear sleeve and deionizer forms one pressure stage are installed in the internal space of the housing on the current-carrying rod with said consecutive alternation of M times to form M pressure stages.

46. An electrodynamic energy converter as claimed in claim 35, wherein the electrodynamic energy converter comprises plurality of modules connected in series, in so doing the output channel of each previous module being connected to the input channel of each next module.

47. A refrigerating plant comprising a compressor, a condenser, a throttling device, an evaporator, wherein the compressor is an electrodynamic energy converter according to any of claims 1 to 3.

48. A refrigerating plant as claimed in claim 47, wherein the compressor has cooling fins on an outside surface for cooling down the working medium.

49. A refrigerating plant comprising units connected in series through the pipelines of working medium pipes, said units including: a compressor, a condenser, a throttling device, an evaporator located in a cooling chamber of a cold consumer, a device for connection the compressor to an A.C. power supply network and regulation of the cold producing capacity of the refrigerating plant having at least one output connected to the compressor, and a temperature control device to control the temperature in the cooling chamber including a temperature detector placed inside the cooling chamber of the cold consumer, a temperature controller and a matching unit, characterized in that the compressor is an electrodynamic energy converter according to any of claims 35 to 46, the device for connection of the compressor further comprises a high-voltage D.C. source which is made with a possibility of continuous control of the voltage at its outputs, electrically connected to the matching unit and has a number of outputs at least corresponding to the number modules in said electrodynamic energy converter, and the value of the voltage at each of the outputs is differentiated, the current-carrying member of each module being connected to one of the outputs of the high-voltage D.C. source.

50. A refrigerating plant as claimed in claim 49, wherein the regulation of the cold producing capacity is effected by varying the value of the voltage at the outputs of the high-voltage D.C. sources.

51. A refrigerating plant as claimed in claim 49 or 50, wherein the value of the voltage at the outputs of the high-voltage D.C. source is set up discretely and controlled by steps of about 10 kV to about 20 kV.
